(19) United States
(12) Patent Application Publication
(10) Pub. No.: US 2015/0303440 A1
(43) Pub. Date: Oct. 22, 2015

(54) Power Supply Connection Device, and Battery Pack Including Same

(71) Applicant: SK INNOVATION CO.,LTD., Jongno-gu, Seoul (KR)

(72) Inventors: SeiHoon Cho, Daejeon (KR); Yun Nyoung Lee, Daejeon (KR); SooJeong Jeong, Daejeon (KR); KeNeth Kim, Daejeon (KR); Seon Yong Kim, Daejeon (KR); JiYoon Lee, Daejeon (KR); YoungHwan Eum, Daejeon (KR); KyuMin Hwang, Daejeon (KR); SeungSoo Jang, Daejeon (KR)

(21) Appl. No.: 14/647,624

(22) PCT Filed: Nov. 8, 2013
(86) PCT No.: PCT/KR2013/010137

§ 371 Date: May 27, 2015

(30) Foreign Application Priority Data
Nov. 27, 2012 (KR) 10-2012-0135069

(51) Int. Cl. H01M 2/34; H01R 13/70

(52) U.S. Cl. CPC H01M 2/34; H01R 13/70; H01M 2220/20; H01M 2200/00

(57) ABSTRACT

Provided is a battery for a secondary cell, and more particularly, a power supply connection device for an electrical connection of a battery and a battery pack including the same.

### TECHNICAL FIELD

The present invention relates to a battery for a secondary cell, and more particularly, to a power supply connection device for an electrical connection of a battery, and a battery pack including the same.

### BACKGROUND ART

In general, a battery used in a vehicle and a high capacity electrical device supplies power through a power supply cable, and the power supply cable is connected to the battery through a terminal. In addition, terminals are formed at both ends of each of a plurality of bus bars in the battery and are connected to each other through a port. The terminal has various shapes depending on a shape of the port of the battery or the bus bar, and an annular ring terminal is typically and widely used.

In the majority of cases, when the terminals are fastened, the terminals are coupled by inserting the terminals into the port and clamping the terminals using nuts, and particularly, a power supply line terminal connected to a high voltage may generate an arc or spark during a fastening process, and when the coupling of the fastened terminal is not tight, resistance is increased, which may cause damage to the battery due to overheating. In a case in which the coupling between the terminals is perfectly separated, since battery power is not applied, a system or a user may accurately recognize the separation of the coupling and take a measure, but in a case in which the coupling between the terminals is not tight, that is, in a case in which the terminals are connected to each other, but a connection state is unstable, since an operation is maintained in a state in which the system or the user does not recognize the coupling which is not tight, the above-mentioned problems are more likely to occur.

Particularly, in a case in which the battery is provided in a means of transportation such as the vehicle, a nut coupling may be loosen due to vibration and impact according to a movement of the vehicle, and consequently, when the terminal coupling is abnormally fastened, and the system or the user does not accurately detect the coupling state of the terminals, the above-mentioned problems may occur.

Therefore, there is a need to develop a technology of a power supply connection device capable of stopping an operation of the battery by sensing the coupling state of the terminals and sensing the abnormal coupling between the terminals, for example, a case in which the terminals are not coupled by predetermined pressure or more as well as a case in which the terminals are perfectly separated.

### DISCLOSURE

### Technical Problem

An object of the present invention is to provide a power supply connection device capable of sensing even an abnormal coupling of terminals by configuring a switch at a terminal connection part, wherein the switch is connected only in a case in which a predetermined load is applied and is interrupted in a case in which a load below the predetermined load is sensed, and a battery pack including the same.

Particularly, an object of the present invention is to provide a power supply connection device capable of preventing an over-current from being applied to a high voltage line by disposing the switch in series on the high voltage line of a battery to disconnect the high voltage line upon the interruption of the switch, and a battery pack including the same.

### Technical Solution

In one general aspect, a power supply connection device includes: a plurality of terminals including coupling holes formed at end portions of power lines; a port part inserted into the coupling hole of each of the plurality of terminals; a coupling member coupled to the port part for a coupling between the plurality of terminals; and a switch part installed between the port part and the coupling member, and interrupted or connected depending on a load by the coupling between the port part and the coupling member.

The port part may further include a port rod into which the coupling hole is inserted, and a port body formed at one end of the port rod.

The switch part may include a sensing body inserted into the port rod so as to be in contact with the other surface of the port body, and a sensing rod coupled to the sensing body so as to be rotatable in a shaft direction of the port rod and having one end which is in contact with one surface of the coupling member to be interlocked depending on a position of the coupling member.

The port rod and the coupling member may be coupled to each other by a screw, and when the coupling member is clamped by a predetermined load or more, the switch part may be connected by a movement of the sensing rod in one side direction, and when the coupling member is released by a load which is less than the predetermined load, the switch part may be interrupted by a movement of the sensing rod in the other side direction.

The switch part may include load cells provided between the port part and the terminals or between the coupling member and the terminals.

The switch part may be connected onto the power line, when a predetermined load or more is applied by the coupling of the coupling member, the switch part may be connected to maintain a connection of the power line, and when a load which is less than the predetermined load is applied, the switch part may be interrupted to disconnect the power line.

When a plurality of power supply connection devices are provided, the respective switch parts may be connected in series with each other on the power line, to thereby disconnect the power line even in a case in which only any one of the respective switch parts is interrupted.

In another general aspect, a battery pack includes the power supply connection device as described above.

The battery pack may further include a power supply control line connected to a battery management system, wherein the switch part of the power supply connection device is connected in series on the power supply control line to transfer an interrupt signal to the battery management system when the switch part is interrupted.

When the plurality of power supply connection devices are provided, the respective switch parts may be connected in series with each other on the power supply control line, to thereby transfer the interrupt signal to the battery management system even in a case in which only any one of the respective switch parts is interrupted.

### Advantageous Effects

The power supply connection device and the battery pack including the same according to the present invention having the configuration as described above sense the coupling state of the terminals and disconnect the system to which the terminals are connected, in a case in which the coupling of the terminals is not tight, thereby making it possible to prevent damage on the battery due to an application of the over-current such as a short-circuit of a high voltage line. In addition, since an abnormal terminal coupling in a range in which the battery management system or the user does not recognize may be sensed, the abnormal coupling of the terminals which may be caused by vibration of a moving vehicle and damage on the battery which may be caused accordingly may be particularly prevented in advance, and an accident caused by the damage on the battery of the moving vehicle may be prevented.

### DESCRIPTION OF DRAWINGS

FIG. 1 is an overall perspective view of a power supply connection device according to the present invention.

FIG. 2 is an exploded perspective view of a power supply connection device according to a first exemplary embodiment of the present invention.

FIG. 3 is a cross-sectional view taken along a line A-A according to the first exemplary embodiment of FIG. 1 (upon a switch on).

FIG. 4 is a cross-sectional view taken along a line A-A according to the first exemplary embodiment of FIG. 1 (upon a switch off).

FIG. 5 is a cross-sectional view taken along a line A-A according to a second exemplary embodiment of FIG. 1.

FIG. 6 is a schematic view of an exemplary embodiment in which the power supply connection device according to the present invention is connected.

FIG. 7 is a wiring connection view of a battery pack according to a third exemplary embodiment of the present invention.

FIG. 8 is a wiring connection view of a battery pack according to a fourth exemplary embodiment of the present invention.

### DETAILED DESCRIPTION OF MAIN ELEMENTS

10: port part 11: port body
12: port rod
20, 200: switch part 21: sensing body
22: sensing rod
30: coupling member
40: first terminal 50: second terminal
L: power line B: battery management system
1000, 2000: battery pack 1100, 2100: power supply connection device
1200, 2200: battery 1300, 2300: motor
1400, 2400: power relay control port
1500: power supply connection control port
1600, 2600: power relay assembly

### BEST MODE

Hereinafter, exemplary embodiments of a power supply connection device according to the present invention will be described in detail with reference to the accompanying drawings.

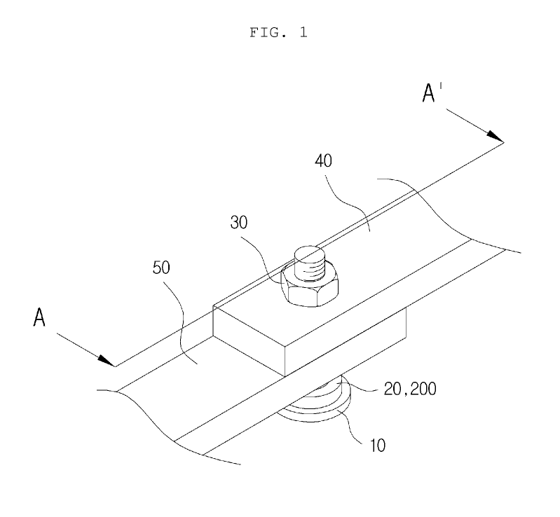

Referring to FIG. 1, a power supply connection device according to an exemplary embodiment of the present invention is configured to include a first terminal 40 formed at an end of a cable or a bus bar, a second terminal 50 formed at an end of the cable or the bus bar for an electrical connection with the first terminal 40, a port part 10 and a coupling member 30 electrically connecting the first terminal 40 and the second terminal 50 to each other and firmly fixing the first terminal 40 and the second terminal 50 at the same time, and a switch part 20 and 200 installed at the port part 10 to sense a coupling state of the first terminal 40 and the second terminal 50.

Although the drawing shows a configuration in which the first terminal 40 and the second terminal 50 are coupled to each other by the port part 10, it will be apparent that the power supply connection device according to the present invention may be applied to a case in which a single terminal and the port part are coupled to each other.

Hereinafter, a description will be provided according to a first exemplary embodiment and a second exemplary embodiment which are classified depending on a configuration of the switch part 20 and 200. For convenience, the description will be provided by defining a lower portion of the drawing as one side and an upper portion of the drawing as the other side.

### First Exemplary Embodiment (Switch Type)

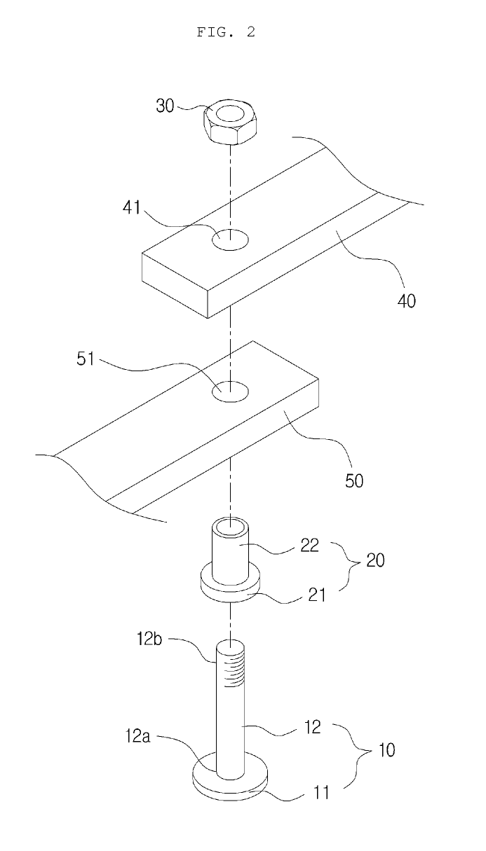

Referring to FIGS. 2 to 4, a first coupling hole 41 is formed in the first terminal 40 so that the port part 10 is inserted, and a second coupling hole 51 is formed in the second terminal 50 so that the port part 10 is inserted. Although the present exemplary embodiment describes a configuration of a ring terminal in which cross sections of the first and second coupling holes 41 and 51 are formed in a circular shape, it will be apparent that the cross section of the coupling hole may be formed in various shapes in which the port part 10 may be inserted. In addition, the first and second coupling holes 41 and 51 may be varied depending on shapes of the port part 10 and a coupling member 30 to be described below.

The port part 10 includes a port rod 12 inserted into the first and second coupling holes 41 and 51 to connect the first terminal 40 and the second terminal 50 to each other, and a port body 11 formed at one end portion 12a of the port rod to have a diameter larger than that of the port rod 12 and formed integrally with the port rod 12. The port body 11 is configured to prevent the second terminal 50 inserted into the port rod 12 from being deviated to an outer side of one end portion 12a of the port rod. The coupling member 30 is coupled and fixed to the other end portion 12b of the port rod. Typically, male screw threads are formed on an outer surface of the other end portion 12b of the port rod and the coupling member 30 may be a nut. Therefore, the port part 10 and the coupling member 30 may be coupled to each other by a screw. The coupling member 30 is coupled to the other end portion 12b of the port rod by the screw in a state in which the second terminal 50 and the first terminal 40 are sequentially inserted. That is, it is possible to prevent the first terminal 40 from being deviated to the outer side of the other end portion 12b of the port rod by the screw coupling between the coupling member 30 and the port rod 12. In addition, by coupling the coupling member 30 to the port rod 12 at a predetermined load or more, the first and second terminals 40 and 50 are in contact with each other to be electrically connected to each other, and the first and second terminals 40 and 50 are firmly coupled to each other. In this case, in order to sense a coupling state of the first and second terminals 40 and 50, a switch part 20 may be installed on the port part 10.

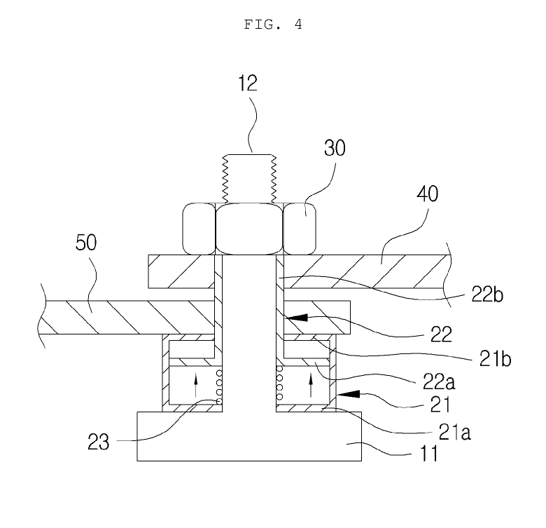

The switch part 20 includes a sensing body 21 and a sensing rod 22. The sensing body 21 is formed in a ring shape so as to be inserted into the port rod 12 and has a space formed therein so that one end portion 22a of the sensing rod is rotatable. The sensing body 21 may be disposed between the other end portion 11a of the port body and one end portion 50a of the second terminal. The sensing rod 22 is configured so that one end portion 22a of the sensing rod is accommodated in the sensing body 21 to be slidable along a shaft direction of the port rod 12. An elastic member 23 is provided between one end portion 21a of the sensing body and one end portion 22a of the sensing rod, such that a state in which one end portion 22a of the sensing rod is always in contact with the other end portion 21b of the sensing body as shown in FIG. 4 is maintained, unless force of a predetermined load or more is applied. As the elastic member 23, a typical coil spring may be used to apply elasticity in order to be able to maintain the state in which one end portion 22a of the sensing rod is in contact with the other end portion 21b of the sensing body.

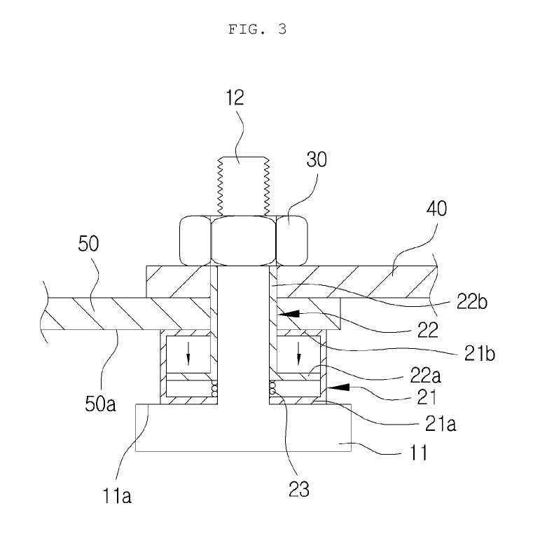

The other end portion 22b of the sensing rod is configured to be in contact with one surface of the coupling member 30 and is configured to be interlocked depending on a position of the coupling member 30. That is, as a clamping load of the coupling member 30 is increased, the sensing rod 22 is configured to approach one end portion 21a of the sensing body as shown in FIG. 3, and as the clamping load of the coupling member 30 is decreased, the sensing rod 22 is configured to be apart from one end portion 21a of the sensing body.

When the coupling member 30 is coupled to the port rod 12 at the predetermined load or more by the configuration as described above, that is, when the coupling member 30 is clamped and coupled to the port rod 12, the switch part 20 is connected by a movement of the sensing rod 22 in one side direction, and when the coupling member 30 is coupled to the port rod 12 at a load which is less than the predetermined load, that is, when the coupling member 30 is released from the port rod 12, the switch part 20 is interrupted by a movement of the sensing rod 22 in the other side direction.

That is, the switch part 20 performs a switching function which is connected or interrupted depending on a clamping state of the coupling member 30. The switch part 20 is connected in series with a power line to which the terminal intends to connect, to thereby connect or disconnect the power line depending on the connection or the interruption of the switch part 20.

By the configuration as described above, the coupling state of the terminal is sensed and the power line to which the terminal is connected is disconnected in a case in which the terminal is not firmly coupled, thereby making it possible to prevent damage on the battery due to an application of an over-current such as a short-circuit of a high voltage line.

In addition, it is apparent that the switching load of the switch part 20 according to the clamping of the coupling member 30 may be variously modified depending on strength of the terminal and coupling requirements of the terminal.

FIG. 3 shows a state in which the first terminal 40 and the second terminal 50 are firmly coupled by coupling the coupling member 30 to the port rod 12 at the predetermined load or more, and consequently, one end portion 22a of the sensing rod is positioned to be adjacent to one end portion 21a of the sensing body.

FIG. 4 shows a state in which the first terminal 40 and the second terminal 50 are coupled to be spaced apart from each other by a predetermined distance by coupling the coupling member 30 to the port rod 12 at the load which is less than the predetermined load, and consequently, one end portion 22a of the sensing rod is positioned to be adjacent to the other end portion 21b of the sensing body.

Since an abnormal terminal coupling in a range in which the system or the user does not recognize may be sensed, the abnormal coupling of the terminals which may be caused by vibration of a moving vehicle and damage on the battery which may be caused accordingly may be particularly prevented in advance, and an accident caused by the damage on the battery of the moving vehicle may be prevented.

### Second Exemplary Embodiment (Load Cell Type)

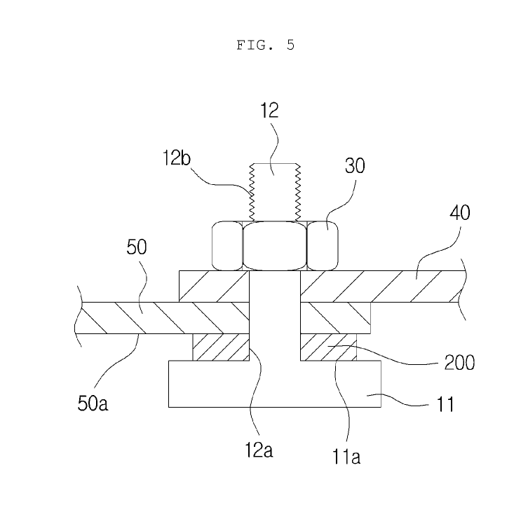

Referring to FIG. 5, a port part 11 and 12 includes a port rod 12 connecting the first terminal 40 and the second terminal 50 to each other, and a port body 11 formed at one end portion 12a of the port rod to have a diameter larger than that of the port rod 12 and formed integrally with the port rod 12. The port body 11 is configured to prevent the second terminal 50 inserted into the port rod 12 from being deviated to an outer side of one end portion 12a of the port rod. The coupling member 30 is coupled and fixed to the other end portion 12b of the port rod. Typically, male screw threads are formed on an outer surface of the other end portion 12b of the port rod and the coupling member 30 may become a nut. Therefore, the port part 10 and the coupling member 30 may be coupled to each other by a screw. That is, it is possible to prevent the first terminal 40 from being deviated to the outer side of the other end portion 12b of the port rod by the screw coupling between the coupling member 30 and the port rod 12. In addition, by coupling the coupling member 30 to the port rod 12 at a predetermined load or more, the first and second terminals and 50 are in contact with each other so as to be electrically connected to each other, and the first and second terminals 40 and 50 are firmly coupled to each other. In this case, in order to sense a coupling state between the first and second terminals 40 and 50, a switch part 200 may be installed on the port part 10.

The switch part 200 includes a load cell capable of sensing predetermined pressure. The switch part 200 is formed in a ring shape so as to be inserted into the port rod 12. The switch part 200 may be disposed between the other end portion 11a of the port body and one end portion 50a of the second terminal.

The load cells have a strain gauge mounted thereon, wherein the strain gauge converts strain (torsion) around the body into electrical resistance and is connected to a load button. When a load is applied to the load button, strain which is proportional to stress occurs, and since the electrical resistance of the strain gauge is changed depending on the strain, the load cell directly displays the load numerically by converting a change in a flowing current into an electrical signal of digital. Examples of the load cell include a compression type, a tension type, and a combination thereof.

When the coupling member 30 is coupled to the port rod 12 at the predetermined load or more by the configuration as described above, that is, when the coupling member 30 is clamped and coupled to the port rod 12, the switch part 200, which becomes the load cell, senses the coupling between the coupling member 30 and the port rod 12 by the predetermined load or more and the switch part 200 is connected, and, and when the coupling member 30 is coupled to the port rod 12 at a load which is less than the predetermined load, that is, when the coupling member 30 is released from the port rod 12, the switch part 200, which becomes the load cell, senses the coupling between the coupling member 30 and the port rod 12 by the load which is less than the predetermined load and the switch part 200 is interrupted.

That is, the switch part 200 performs a switching function which is connected or interrupted depending on a clamping state of the coupling member 30. The switch part 200 is connected in series with a power line to which the terminal intends to connect, to thereby connect or disconnect the power line depending on the connection or the interruption of the switch part 200.

By the configuration as described above, the coupling state of the terminal is sensed and the power line to which the terminal is connected is disconnected in a case in which the terminal is not firmly coupled, thereby making it possible to prevent damage on the system due to an application of an over-current such as a short-circuit.

Hereinafter, an installation example in which the power supply connection device according to the exemplary embodiment of the present invention having the configuration as described above is applied will be described with reference to the accompanying drawings.

### Installation Example

A main object of the power supply connection device according to the exemplary embodiment of the present invention is to interrupt the power line of the system by sensing the abnormal coupling state of the terminals. Therefore, the power supply connection device according to the exemplary embodiment of the present invention may be very usefully used when being applied to a bus bar connection structure in a battery pack.

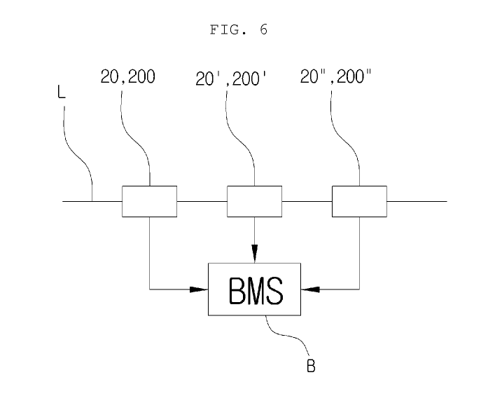

Referring to FIG. 6, the switch part 20 and 200 according to the exemplary embodiment of the present invention may be installed on a power line 100 of the battery pack. Specifically, the switch part 20 and 200 may be connected in series on the power line L. Therefore, if the switch part 20 and 200 senses the load which is less than the predetermined load, the switch part 20 and 200 is interrupted to disconnect the power line 100.

In a case of a system in which a plurality of terminal coupling sensing devices are provided, a plurality of switch parts 20 and 200, 20′ and 200′, and 20″ and 200″ according to an exemplary embodiment of the present invention may be connected in series with each other on the power line L. Therefore, if any one of the plurality of switch parts 20 and 200, 20′ and 200′, and 20″ and 200″ senses the load which is less than the predetermined load, any one of the plurality of switch parts 20 and 200, 20′ and 200′, and 20″ and 200″ is interrupted to disconnect the power line 100.

In addition, the plurality of switch parts 20 and 200, 20′ and 200′, and 20″ and 200″ are configured to be each connected to a battery management system B to transfer the coupling state of the terminals to the battery management system.

Hereinafter, an exemplary embodiment of the battery pack including the power supply connection device according to the present invention as described above will be described in detail with reference to the accompanying drawings.

### Third Exemplary Embodiment

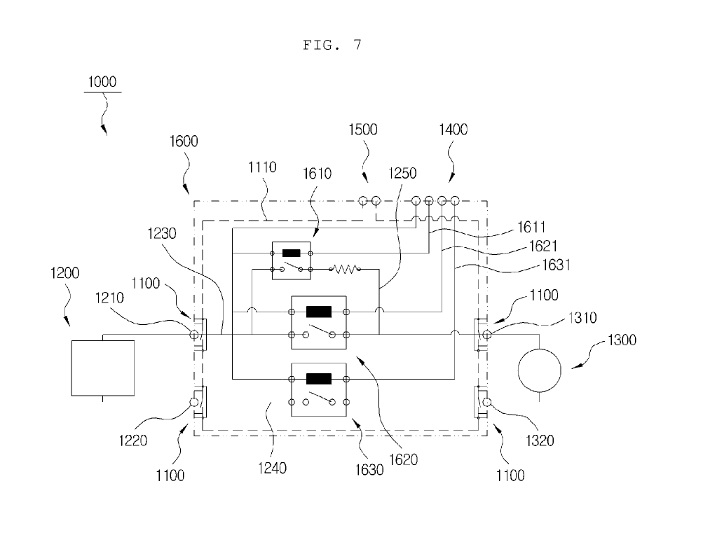

Referring to FIG. 7, a battery pack 1000 according to a third exemplary embodiment of the present invention is configured to include a plurality of power supply connection devices 1100, a battery 1200, a power relay control port 1400, a power supply connection control port 1500, and a power relay assembly 1600. In addition, a motor 1300 and a battery management system (not shown) may be connected to the battery pack 1000.

As the battery 1200, a typical battery for a secondary cell for supplying power to the motor 1300 is used and includes a first cathode terminal 1210 and a first anode terminal 1220, respectively. As the motor 1300, a typical motor which is driven by power is used and includes a second cathode terminal 1310 and a second anode terminal 1320. The power relay assembly 1600 is configured to include a cathode line 1230 connected to the first cathode terminal 1210 and the second cathode terminal 1310, an anode line 1240 connected to the first anode terminal 1220 and the second anode terminal 1320, a cathode relay 1620 provided on the cathode line 1230, an anode relay 1630 provided on the anode line 1240, a free charge line 1250 connected in parallel to the cathode line 1230, and a free charge relay 1610 provided on the free charge line 1250.

The free charge relay 1610, the cathode relay 1620, and the anode relay 1630 are connected to a first signal line 1611, a second signal line 1621, and a third signal line 1631, respectively, and the power relay control ports 1400 are provided to ends of the first signal line 1611, the second signal line 1621, and the third signal line 1631 to transfer information of the free charge relay 1610, the cathode relay 1620, and the anode relay 1630 to the battery management system.

In this case, the power supply connection devices 1100 may be provided to connection parts between the first cathode terminal 1210 and the cathode line 1230, between the second cathode terminal 1310 and the cathode line 1230, between the first anode terminal 1220 and the anode line 1240, and between the second anode terminal 1320 and the anode line 1240, respectively.

The respective power supply connection devices 1100 are connected in series with each other on a power supply connection line 1110, and the power supply connection control port 1500 is provided to an end of the power supply connection line 1110. The power supply connection control port 1500 is connected to the battery management system to transfer whether or not the respective power supply connection devices are connected or interrupted to the battery management system.

In a case in which abnormal couplings of one or more of the connection parts between the first cathode terminal 1210 and the cathode line 1230, between the second cathode terminal 1310 and the cathode line 1230, between the first anode terminal 1220 and the anode line 1240, and between the second anode terminal 1320 and the anode line 1240 are sensed by the configuration as described above, the abnormal couplings are transferred to the battery management system through the power supply connection device 1100, the power supply connection line 1110, and the power supply connection control port 1500.

### Fourth Exemplary Embodiment

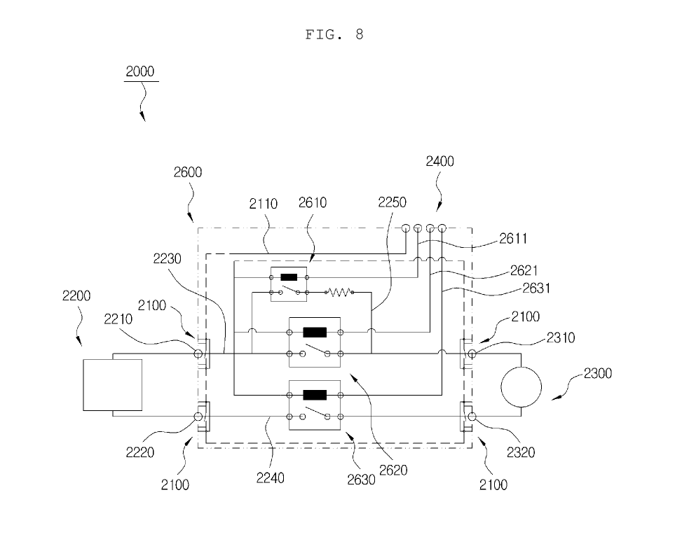

Referring to FIG. 8, a battery pack 2000 according to a fourth exemplary embodiment of the present invention is configured to include a plurality of power supply connection devices 2100, a battery 2200, a power relay control port 2400, a power supply connection control port 2500, and a power relay assembly 2600. In addition, a motor 2300 and a battery management system (not shown) may be connected to the battery pack 2000.

The battery pack 2000 according to the fourth exemplary embodiment of the present invention has the same detail configuration as the battery pack 1000 according to the third exemplary embodiment of the present invention described above, except for a connection structure of the power supply connection devices 2100. Therefore, only the connection structure of the power supply connection devices 2100 will be described in detail.

The power supply connection devices 2100 may be provided to connection parts between a first cathode terminal 2210 and a cathode line 2230, between a second cathode terminal 2310 and the cathode line 2230, between a first anode terminal 2220 and an anode line 2240, and between a second anode terminal 2320 and the anode line 2240, respectively.

The respective power supply connection devices 2100 are connected in series with each other on a power supply connection line 2110, and the power supply connection line 2110 is connected to the power relay control port 2400. Therefore, whether or not the respective power supply connection devices 2100 are connected or interrupted is transferred to the battery management system.

In a case in which abnormal couplings of one or more of the connection parts between the first cathode terminal 2210 and the cathode line 2230, between the second cathode terminal 2310 and the cathode line 2230, between the first anode terminal 2220 and the anode line 2240, and between the second anode terminal 2320 and the anode line 2240 are sensed by the configuration as described above, the abnormal couplings are transferred to the battery management system through the power supply connection device 2100, the power supply connection line 2110, and the power relay control port 2400.

The present invention should not be construed to being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall within the scope of the present invention.

1. A power supply connection device comprising:
a plurality of terminals including coupling holes formed at end portions of power lines;
a port part inserted into the coupling hole of each of the plurality of terminals;
a coupling member coupled to the port part for a coupling between the plurality of terminals; and
a switch part installed between the port part and the coupling member, and interrupted or connected depending on a load by the coupling between the port part and the coupling member.

2. The power supply connection device of claim 1, wherein the port part includes a port rod into which the coupling hole is inserted, and a port body formed at one end of the port rod.

3. The power supply connection device of claim 2, wherein the switch part includes a sensing body inserted into the port rod so as to be in contact with the other surface of the port body, and a sensing rod coupled to the sensing body so as to be rotatable in a shaft direction of the port rod and having one end which is in contact with one surface of the coupling member to be interlocked depending on a position of the coupling member.

4. The power supply connection device of claim 3, wherein the port rod and the coupling member are coupled to each other by a screw, and
when the coupling member is clamped by a predetermined load or more, the switch part is connected by a movement of the sensing rod in one side direction, and when the coupling member is released by a load which is less than the predetermined load, the switch part is interrupted by a movement of the sensing rod in the other side direction.

5. The power supply connection device of claim 1, wherein the switch part includes load cells provided between the port part and the terminals or between the coupling member and the terminals.

6. The power supply connection device of claim 1, wherein the switch part is connected onto the power line, when a predetermined load or more is applied by the coupling of the coupling member, the switch part is connected to maintain a connection of the power line, and when a load which is less than the predetermined load is applied, the switch part is interrupted to disconnect the power line.

7. The power supply connection device of claim 6, wherein when a plurality of power supply connection devices are provided, the respective switch parts are connected in series with each other on the power line, to thereby disconnect the power line even in a case in which only any one of the respective switch parts is interrupted.

8. A battery pack including the power supply connection device of claim 1.

9. The battery pack of claim 8, further comprising a power supply control line connected to a battery management system,
wherein the switch part of the power supply connection device is connected in series on the power supply control line to transfer an interrupt signal to the battery management system when the switch part is interrupted.

10. The battery pack of claim 9, wherein when the plurality of power supply connection devices are provided, the respective switch parts are connected in series with each other on the power supply control line, to thereby transfer the interrupt signal to the battery management system even in a case in which only any one of the respective switch parts is interrupted.
